(19) United States
(12) Patent Application Publication
(10) Pub. No.: US 2019/0374800 A1
(43) Pub. Date: Dec. 12, 2019

(54) TURBINE ASSEMBLY FOR DRIVING A PUMP OF A FIRE EXTINGUISHING SYSTEM, AND A TURBINE WHEEL IN SAID TURBINE ASSEMBLY

(71) Applicant: FireProducts AS, Kristiansand S (NO)

(72) Inventor: Kjetil Sivertsen, Kristiansand (NO)

(73) Assignee: FireProducts AS, Kristiansand S (NO)

(21) Appl. No.: 16/478,665

(22) PCT Filed: Jan. 17, 2018
(86) PCT No.: PCT/NO2018/050011

§ 371 Date: Jul. 17, 2019

(30) Foreign Application Priority Data
Jan. 20, 2017 (NO) 20170092

(51) Int. Cl. A62C 5/00

(52) U.S. Cl. CPC A62C 5/002; A62C 5/02; A62C 5/008

(57) ABSTRACT

A turbine assembly is for driving a pump of a fire extinguishing system, the pump being configured for injection of a chemical into a fire water column. The turbine assembly includes a housing provided with a flow channel extending therethrough for guiding at least a portion of the fire water column through the turbine assembly and a turbine wheel for being arranged in the flow channel. The turbine wheel includes turbine blades and two opposite side portions connected to and separated by the turbine blades. The turbine wheel is provided with openings between the turbine blades in order to provide at least one flow channel through the turbine wheel even when it does not rotate. The at least one flow channel through the turbine wheel starts between two turbine blades, runs through the turbine wheel, and ends between two other turbine blades.

### FIELD

The present invention relates to a turbine assembly for driving a pump of a fire extinguishing system, said pump being configured for injection of a chemical into a fire water column. The turbine assembly comprises a housing provided with a flow channel extending through it for guiding at least a portion of the fire water column through the turbine assembly. The invention also relates to a turbine wheel and a flow guiding device in said turbine assembly. Furthermore, the invention relates to a fire extinguishing system comprising said turbine assembly and a pump arranged to be driven by the turbine assembly.

### BACKGROUND

For a more efficient fire extinguishing than that which may be obtained only from the use of water, it is common to add chemicals which, through a reaction with the water, form foam. There are several types of foams, including protein foams and synthetic foams. Synthetic foam comprises foam forming an aqueous film, so-called AFFF foam (Aqueous Film Forming Foam) and alcohol resistant foam forming aqueous film, so-called AR-AFFF foam (Alcohol Resistant Aqueous Film Forming Foam). The foam cools the fire and coats it in order to prevent it from getting in contact with oxygen. It is important that the chemicals are added to the water in correct amounts, both for achieving as efficient fire extinguishing as possible and for preventing unnecessary high emission of chemicals. The dosage must therefore be accurate and reliable.

It is known to use pump systems in order to pump chemicals into the extinguishing water in a fire fighting system. Such pump systems must be provided with a drive unit in order to work. Many providers of such systems solve this problem by using a so-called proportioner, i.e. a small water motor arranged in and driven by the flow of extinguishing water.

Known solutions use propel turbines or replacement turbines. Examples of providers of such known solutions are the German company FireDos GmbH, the Swedish company Firemiks AB and the Norwegian company Matre Maskin AS.

One disadvantage of systems of known type is that if any foreign object enters into the turbine, the risk is that the turbine will stop and thus no longer drive the pump. Foreign objects in the turbine may therefore cause the power supply to the pump to be unstable, and thus cause unstable feed of chemicals to the water flow. What is worse, though, is that if the turbine is arranged in the main flow for fire extinguishing water, the flow may be blocked and little or no water may pass the turbine, which means there will be no water for extinguishing the fire. Such foreign objects may enter into the fire extinguishing water in cases where the water source is a pond or lake close to the location of the fire.

Another drawback of known systems is that the turbine causes a drop of water pressure and speed, such that the fire extinguishing water reaches the fire with less force than it potentially could.

### SUMMARY

The invention has for its object to remedy or to reduce at least one of the drawbacks of the prior art, or at least to provide a useful alternative to prior art.

The object is achieved through features, which are specified in the description below and in the claims that follow.

The invention is defined by the independent patent claims. The dependent claims define advantageous embodiments of the invention.

More specifically, the invention relates to a turbine assembly for driving a pump of a fire extinguishing system, said pump being configured for injection of a chemical into a fire water column, wherein the turbine assembly comprises:
a housing provided with a flow channel extending therethrough for guiding at least a portion of the fire water column through the turbine assembly;
a turbine wheel for being arranged in the flow channel, wherein said turbine wheel comprises turbine blades. The characterizing features of the invention is that the turbine wheel further comprises two opposite side portions connected to and separated by said turbine blades, and that the turbine wheel is provided with openings between the turbine blades in order to provide at least one flow channel through the turbine wheel even when it does not rotate, wherein the at least one flow channel through the turbine wheel starts between two turbine blades, runs through the turbine wheel, and ends between two other turbine blades.

The term “openings between the turbine blades” will be elaborated in the following. The necessary feature of the turbine wheel is to provide a flow path, or possible flow route, for water through the turbine wheel such that even if the turbine wheel is blocked from rotating, water may still pass through. For this to be fulfilled, at least one opening, or flow channel, has to be made through the turbine wheel. Such a flow channel typically starts between two turbine blades, runs through the turbine wheel and ends between two other turbine blades. The flow channel through the turbine wheel connects the flow channel upstream of the turbine wheel to the flow channel downstream of the turbine wheel. Of course, the more flow channels there are provided through the turbine wheel, the more water will be able to flow through the turbine wheel. In one embodiment there may even be provided openings between all of the turbine blades.

The invention thus relates to a turbine assembly wherein the turbine wheel is arranged in the flow of water for fire extinguishing, but because of the openings between the turbine blades, providing a flow channel through the turbine wheel, the turbine will produce less power from the water than if there were no openings. This means that the turbine is less efficient in producing power, but also that it does not reduce the speed of the water more than necessary. The purpose of the invention is to provide a turbine which provides enough power to run the pump, but not more than necessary. Furthermore, the openings between the turbine blades have the effect that if the turbine wheel for some reason is stopped, for instance because of a foreign object as mentioned above, the water for fire extinguishing will still be able to pass through. This is crucial when there is no time to lose.

The turbine wheel may be hollow. By “hollow” is herein meant that the turbine wheel does not have a through shaft. The effect of such a hollow turbine wheel is that the turbine wheel becomes lighter, i.e. consists of less material, than a turbine wheel comprising a solid, through shaft. This again has the effect that the turbine wheel is more easily turned, i.e. less force is required in order to turn the turbine wheel. Another effect is that, in case the turbine wheel stops as described above, water may more easily run through the turbine wheel.

The turbine wheel may be made in one piece. An advantage of this is that the risk of any loose parts breaking off the turbine wheel, which could possibly damage other parts of the fire extinguishing system, is eliminated. Another advantage is that the production of the turbine wheel can be made more accurate and cost efficient when there is no need for extensive welding operations. In addition, the extra stress that welding would put on the material, will be avoided.

The turbine wheel may preferably be produced by means of wire cutting. This is a very accurate production method. The turbine wheel will thus be balanced and ready for use in much shorter time than if produced by other means.

The turbine wheel may be connected to the housing by means of a shaft mounted on one of the side portions, and an opposing shaft mounted on the second of the side portions. This means that each of the side portions of the turbine wheel is connectable to the housing by means of an axle. In this embodiment, two opposing axles arranged on the two opposing sides of the turbine wheel, will connect the turbine wheel to the walls of the flow channel of the turbine assembly. This is a particularly stable way of connecting the turbine wheel to the housing. In a fire extinguishing system, the water column, i.e. the firewater, is pumped through at a high speed and the turbine wheel needs to be able to keep its position when exposed to the pressure of the water. A single shaft only connecting one side portion of the turbine wheel to the housing would make the turbine assembly less suitable for use in a fire extinguishing system, for instance because of water hammers occurring in the flow channel.

The turbine assembly may further comprise a flow guiding device arranged in the flow channel, for guiding the water in a desired direction.

The flow channel of the turbine assembly starts at an inlet portion of the housing and ends at an outlet portion of the housing. The flow guiding device may comprise an inlet flow guiding device which is arranged in connection with the inlet portion of the housing, upstream of the turbine wheel. This inlet flow guiding device is for guiding water in a desired direction towards the turbine wheel. The inlet flow guiding device comprises an opening for being in fluid communication with, or forming part of, the flow channel of the turbine assembly. Said opening may be shaped such that water is directed in a desired direction, for instance by inclination of the walls of the opening.

In another embodiment the opening may be divided into a plurality of openings by means of inclined walls or partitions such that portions of the water column are diverted in different directions from each other.

Furthermore, the flow guiding device may comprise an outlet flow guiding device which is arranged in connection with the outlet portion of the housing, downstream of the turbine wheel. This outlet flow guiding device is for collecting the water in a more uniform flow when it leaves the turbine assembly, than what it is when it leaves the turbine wheel.

In a second aspect the invention relates more particularly to the turbine wheel in the turbine assembly according to the first aspect of the invention.

In a third aspect the invention relates more particularly to the flow guiding device in the turbine assembly according to the first aspect of the invention.

The flow guiding device may be arranged to be connected to the housing and provided with an opening delimited by at least one inclined surface for directing the water. The flow guiding device may typically be arranged such that it comprises a flow channel which, when the flow guiding device is connected to, or placed adjacent to the housing, constitutes a continuation of the flow channel of the housing.

The flow guiding device may comprise of an inlet flow guiding device, an outlet flow guiding device, or both, as described above. The inclined surface of the inlet flow guiding device will be arranged such that the firewater is guided in a desired direction with regards to hitting the turbine blades at an optimal angle. It must be understood that in another embodiment, the inlet flow guiding device may be an integral part of the housing or a separate part attached to the inside of the housing upstream of the turbine wheel. The important feature is that the inlet flow guiding device is arranged such that it can guide the water column in a desired direction with regards to the turbine blades. By the term “desired direction” is herein meant a direction which causes the water to add to the speed of the turbine wheel.

The flow guiding device may be arranged to divide the water column into at least two water columns by means of partitions of the opening in the guiding device. This means that the opening may be divided into a plurality of openings by means of inclined walls or partitions such that portions of the water column are diverted in different directions from each other.

Furthermore, the flow guiding device may comprise an outlet flow guiding device which is arranged in connection with the outlet portion of the housing, downstream of the turbine wheel. This outlet flow guiding device is for collecting the water in a more uniform flow when it leaves the turbine assembly, than what it is when it leaves the turbine wheel.

In a fourth aspect the invention relates more particularly to a fire extinguishing system comprising the turbine assembly according to the first aspect of the invention, wherein the system further comprises a pump arranged to be driven by the turbine assembly. The effect of using a turbine assembly as the one described herein, is that it does not maximize the power production, but it optimizes it. This basically means that the turbine assembly is not the most efficient turbine assembly when it comes to producing power from a water column, but it is intentionally optimized into providing just enough energy to drive the pump for injecting foam into the firewater. It is therefore a clear advantage if the pump and the turbine assembly to drive the pump are adapted to each other.

### BRIEF DESCRIPTION OF THE DRAWINGS

In the following is described an example of a preferred embodiment illustrated in the accompanying drawings, wherein:

FIG. 1 is a schematic overview of a firefighting system comprising a turbine assembly;

FIG. 2 is a cross-section of a turbine assembly according to the invention seen from above;

FIG. 3 is a side view of the turbine assembly of FIG. 2;

FIG. 4A shows a turbine assembly according to the invention installed in a water column and during rotation of the turbine wheel;

FIG. 4B shows the same turbine assembly as in FIG. 4A, still installed in a water column, but where the turbine wheel is not rotating;

FIG. 5 shows a turbine wheel according to the invention; and

FIG. 6 shows a guiding device according to the invention.

### DETAILED DESCRIPTION OF THE DRAWINGS

The figures are shown in a simplified and schematic manner, and details that are not important in order to highlight what is new about the invention may have been omitted from the figures. The various elements in the figures are not necessarily shown to scale relative to each other. Like or corresponding elements will be indicated by the same reference numeral in the figures.

Any positional specifications such as “over”, “under”, “above”, “below”, “left” and “right” reflect the position shown in the figures.

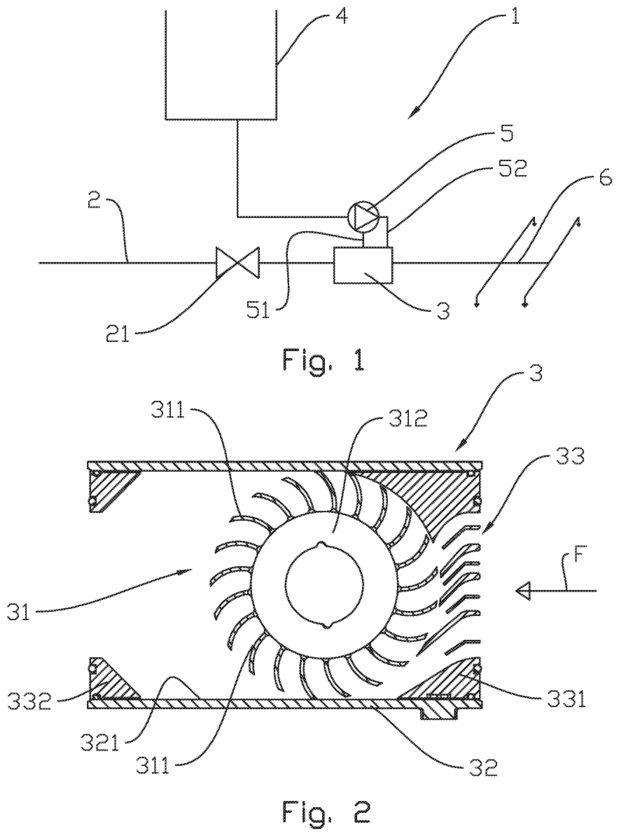

Reference is first made to FIG. 1 showing, in a schematic form, a fire extinguishing system 1. The system 1 comprises a firewater pipe 2 connected to a turbine assembly 3. The firewater pipe 2 is provided with a valve 21 which in an open position will let a column of firewater through to the turbine assembly 3, and in a closed position will close off the water flow. When the valve 21 is in its open position, the firewater column enters through to the turbine assembly 3 and drives a turbine wheel 31 (shown in FIGS. 2-5) therein. The system 1 further comprises a foam tank 4 connected to a pump 5. The pump 5 is connected to the turbine assembly 3 via a connecting means 51 such as an axle, such that when the firewater drives the turbine wheel 31, the turbine assembly 3 provides energy to the pump 5 and an amount of foam is pumped into the firewater column downstream of the turbine wheel 31 via a connecting pipe 52. The firewater column with the added foam then continues through a pipe system 6 as shown, i.e. a deluge sprinkler system, or for instance through a fire hose.

FIG. 2 shows a cross-section of the turbine assembly 3. An arrow F on the figure indicates the flow direction of the firewater column. In addition to the already mentioned turbine wheel 31, the turbine assembly 3 in this embodiment comprises a housing 32. The housing 32 is provided with a flow channel 321 in which the turbine wheel 31 is placed. It can be seen from the figure that the turbine wheel 31 is adapted to the size of the housing 32, or the other way around. The housing 32 is typically a tubular housing such as a tube. The turbine wheel 31 is provided with turbine blades 311 which are curved. The turbine blades 311 may be curved in two directions, both in order to be able to “collect” water and in order to fit inside the tubular housing 32. In this embodiment the turbine assembly 3 further comprises a guiding device 33 for guiding the firewater into the turbine wheel 31. It can be seen from the figure that the guiding device 33 may be split into an inlet flow guiding device 331 and an outlet flow guiding device 332, arranged at an inlet portion of the turbine assembly 3 and at an outlet portion of the turbine assembly 3, respectively. The inlet flow guiding device 331 is arranged to divide the water column of firewater into multiple water columns and bend or divert the flow towards the concave surface of the turbine blades 311. The turbine blades 311 are connected to two opposing side portions 312 of the turbine wheel 31, wherein one of the side portions 312 is shown in FIG. 2 and both are shown in FIG. 5.

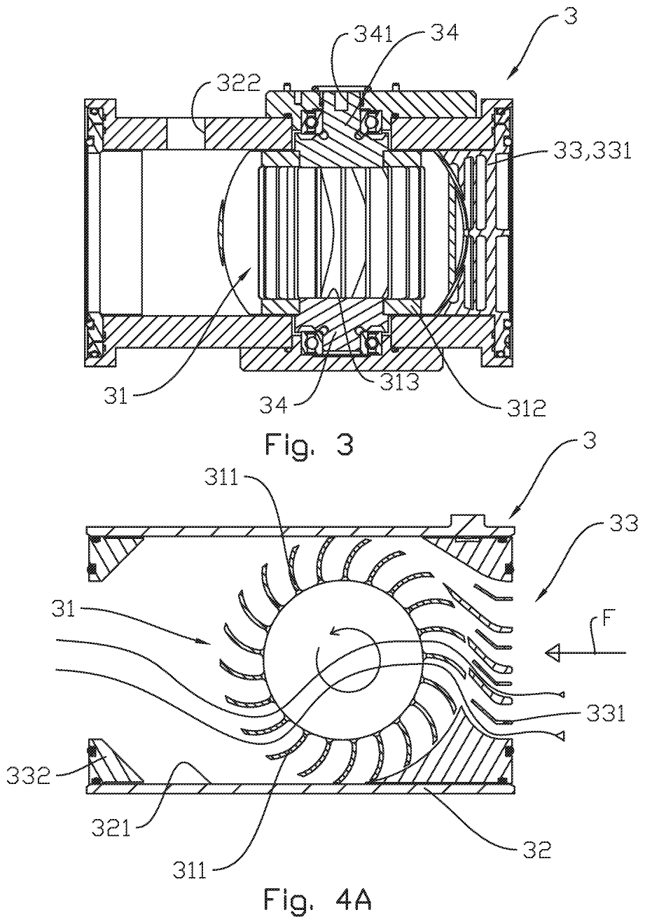

In FIG. 3 it is illustrated how the turbine wheel 31 in one embodiment is connected to the housing 32 of the turbine assembly 3. One of the two side portions 312 of the turbine wheel 31 is connected to a shaft 34 and the other of the two side portions 312 is connected to another, opposite shaft 34 for secure and stable connection of the turbine wheel 31 to the housing 32 without the need for a through shaft which would have taken up space within the turbine wheel 31. Openings 313 in the turbine wheel 31 (better shown in FIG. 5) allow for water to pass through the turbine wheel 31. One of the shafts 34, on FIG. 3 this is the topmost shaft 34, is arranged with an opening 341 for receiving the connecting means 51 (FIG. 1), such as an axle, for connecting the turbine wheel 31 to the pump 5 (FIG. 1). The pump 5 is thereby driven and pumps chemical/foam into the turbine assembly 3 downstream of the turbine wheel 31. The foam enters the turbine assembly 3 through the pipe 52 ending in an opening 322 provided in the housing 32. It must be understood that the foam in an alternative embodiment may be added to the water column at another point in the fire extinguishing system 1.

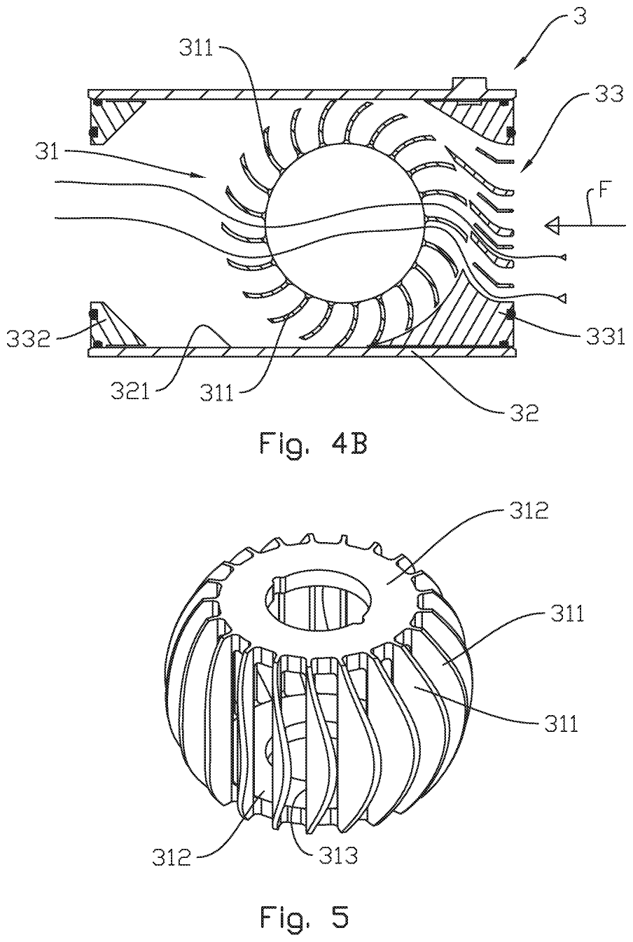

FIG. 4A and FIG. 4B illustrate how the firewater passes through the turbine wheel 31 when the turbine wheel 31 is rotating and when the turbine wheel 31 has stopped rotating, for example due to a foreign element which has entered in the water flow, respectively. When the water flow causes the turbine wheel 31 to rotate, some of the water will pass through the openings 313 of the turbine wheel 31. Due to the rotation of the turbine wheel 31, the water column passing through the turbine wheel 31 will be bent. This is illustrated by two flowlines in FIG. 4A. When the movement of the turbine wheel 31 has been blocked, the openings 313 in the turbine wheel 31 allow for the water column to pass through the turbine wheel 31 in a straighter line. In this case the water column will lose some power in trying to rotate the stuck turbine wheel 31, but since the openings 313 in this embodiment are as big as possible and the turbine wheel 31 is hollow, i.e. without a through shaft, the power loss is minimized.

FIG. 5 shows a turbine wheel 31 machined in one piece, having two side portions 312 adapted to be connected to shafts 34, and multiple turbine blades 311 arranged with openings 313 in between them for allowing firewater to enter through the turbine wheel 31 even when the turbine wheel 31 is not rotating.

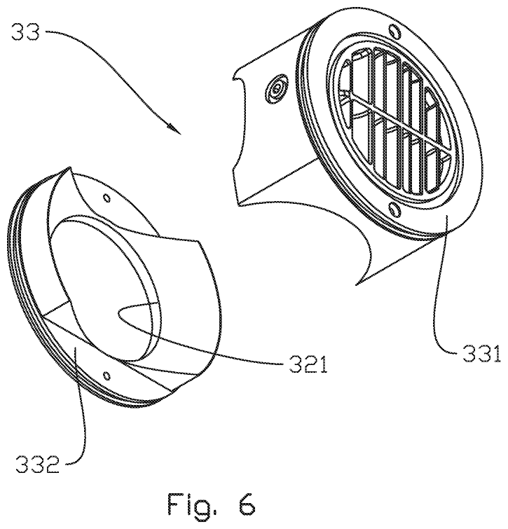

FIG. 6 shows the guiding device 33. The flow guiding device 33 is here shown as two separate parts, an inlet flow guiding device 331 and an outlet flow guiding device 332. The two parts 331, 332 are arranged to be mounted in the flow channel 321 of the turbine assembly 3. The inlet flow guiding device 331 is here shown with a plurality of partitions for dividing the water flow and for guiding the different parts of the water flow at an optimized angle towards the turbine wheel 31 (shown in FIGS. 2-5). The outlet flow guiding device 332 has inclined walls for collecting the water flow and making the water flow which exits the turbine assembly 3 more uniform than the water flow which leaves the turbine wheel 31. The outlet flow guiding device 332 is thus arranged downstream of the turbine wheel 31 and the inlet flow guiding device 331 is arranged upstream of the turbine wheel 31.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. A turbine assembly for driving a pump of a fire extinguishing system, said pump being configured for injection of a chemical into a fire water column, wherein the turbine assembly comprises:
a housing provided with a flow channel extending therethrough for guiding at least a portion of the fire water column through the turbine assembly;
a turbine wheel for being arranged in the flow channel, wherein said turbine wheel comprises turbine blades;
wherein the turbine wheel further comprises two opposite side portions connected to and separated by said turbine blades; wherein the turbine wheel is provided with openings between the turbine blades in order to provide at least one flow channel through the turbine wheel even when it does not rotate; and
wherein the at least one flow channel through the turbine wheel starts between two turbine blades, runs through the turbine wheel, and ends between two other turbine blades.

2. The turbine assembly according to claim 1, wherein the turbine wheel is hollow.

3. The turbine assembly according to claim 1, wherein the turbine wheel is made in one piece.

4. The turbine assembly according to claim 1, wherein the turbine wheel is connected to the housing via a shaft mounted on one of the side portions, and an opposite shaft mounted on the second of the side portions.

5. The turbine assembly according to claim 1, further comprising a flow guiding device arranged in the flow channel for guiding the water in a desired direction.

6. The turbine assembly according to claim 5, wherein the guiding device is arranged to be connected to the housing and provided with an opening delimited by at least one inclined surface for directing the water.

7. The turbine assembly according to claim 5 wherein the guiding device is arranged to divide the water column into at least two water columns via partitions of the opening of the guiding device.

8. A fire extinguishing system comprising the turbine assembly according to claim 1, wherein the system further comprises a pump arranged to be driven by the turbine assembly.

9. A turbine wheel for being arranged in a flow channel of a turbine assembly, said turbine wheel comprising:
turbine blades;
two opposite side portions connected to and separated by said turbine blades; wherein the turbine wheel is provided with openings between the turbine blades in order to provide at least one flow channel through the turbine wheel even when it does not rotate, wherein the at least one flow channel through the turbine wheel starts between two turbine blades, runs through the turbine wheel and ends between two other turbine blades.

10. A guiding device for being arranged in a flow channel of a turbine assembly for driving a pump of a fire extinguishing system, said pump being configured for injection of a chemical into a fire water column, wherein the turbine assembly comprises:
a housing provided with a flow channel extending therethrough for guiding at least a portion of the fire water column through the turbine assembly;
a turbine wheel for being arranged in the flow channel, wherein said turbine wheel comprises turbine blades;
wherein the turbine wheel further comprises two opposite side portions connected to and separated by said turbine blades; wherein the turbine wheel is provided with openings between the turbine blades in order to provide at least one flow channel through the turbine wheel even when it does not rotate; and
wherein the at least one flow channel through the turbine wheel starts between two turbine blades, runs through the turbine wheel, and ends between two other turbine blades;
said guiding device being adapted to guide water in a desired direction in the flow channel via at least one inclined surface.
